(19) United States
(12) Patent Application Publication
(10) Pub. No.: US 2004/0237115 A1
(43) Pub. Date: Nov. 25, 2004

(54) Remote control unit for operating server, and server system including server and remote control unit

(76) Inventors: Koichi Horiuchi, Nara-shi (JP); Hiromichi Shimada, Nishinomiya-shi (JP); Toyohiko Matsuda, Katano-shi (JP); Kuninaga Azuma, Edgewater, NJ (US)

Correspondence Address: RATNERPRESTIA, P O BOX 980, VALLEY FORGE, PA, 19482-0980, US

(21) Appl. No.: 10/847,247

(22) Filed: May 17, 2004

(30) Foreign Application Priority Data
May 19, 2003 (JP) 2003-140132

(51) Int. Cl. H04N 7/173; G06F 13/00; H04N 5/445; G06F 3/00; H04N 7/16

(52) U.S. Cl. 725/116; 725/146; 725/93; 725/58; 725/147

(57) ABSTRACT

A remote control unit can operate a server capable of transmitting contents data, and accept a recording medium. The remote control unit includes a controller for generating a control signal to control the server and the remote control unit, an operation section for switching an operating mode of the remote control unit, a transmitter/receiver operable to transmit the control signal generated by the controller to the server, and to receive the contents data from the server, and a recorder/reproducer. The recorder/reproducer is operable to accept the recording medium, record the contents data received by the transmitter/receiver into the recording medium, reproduce data from the recording medium, and output the data to the transmitter/receiver. According to the control signal generated by the controller based on the operating mode, the recorder/reproducer is operable to switch a function of the remote control unit between a drive belonging to the server and a drive independent from the server.

### FIELD OF THE INVENTION

The present invention relates to a server for recording and reproducing video signals and audio signals, a remote control unit for operating the server, and a server system including the server and the remote control unit.

### BACKGROUND OF THE INVENTION

There are numerous servers in recent years for recording and reproducing video signals and audio signals of a variety of data formats using recording/reproducing devices, such as magnetic disk drives and optical disk drives. The servers preferably not only provide recorded and reproduced contents of images and voices for users to enjoy them on standalone basis, but also allow the users to easily store contents data and retrieve them from the recorded contents, thereby allowing the data to be used with portable apparatuses. For this purpose, the servers need to accept portable recording media.

Memory cards are well-known as such recording media, and are used for a variety of portable apparatuses, such as personal digital assistant equipment, digital still cameras, and solid-state audio players. Conventional servers are provided with card slots for insertion and removal of such memory cards.

Card slots for memory cards may be provided not only in servers, but also in remote control units, as disclosed in Japanese Patent Laid-Open Publication No.2000-30010. The remote control unit accepts a memory card as a recording medium for providing data to expand its functions.

As described, memory cards may be used not only for portable apparatuses but also as bridge media for cooperation with servers.

Various kinds of memory cards are now marketed widely. The cards include memory cards having small sizes of postage stamps, which are useful as the bridge media to allow cooperation between the conventional servers and the portable apparatuses.

Processes of transmitting contents data stored in a server to a memory card having such small size. First, a user inserts the memory card into a card slot of the server. Then, the user operates a remote control unit of the server to select desired contents data of the data stored in the server, and starts recording of the desired contents data into the memory card. Upon completion of the recording, the user removes the memory card from the server.

The above processes are inconvenient since the conventional server requires the user to move to a place where the server is installed when taking the memory card out of the server.

### SUMMARY OF THE INVENTION

A remote control unit can operate a server capable of transmitting contents data, and accept a recording medium. The remote control unit includes a controller for generating a control signal to control the server and the remote control unit, an operation section for switching an operating mode of the remote control unit, a transmitter/receiver operable to transmit the control signal generated by the controller to the server, and to receive the contents data from the server, and a recorder/reproducer. The recorder/reproducer is operable to accept the recording medium, record the contents data received by the transmitter/receiver into the recording medium, reproduce data from the recording medium, and output the data to the transmitter/receiver. According to the control signal generated by the controller based on the operating mode, the recorder/reproducer is operable to switch a function of the remote control unit between a drive belonging to the server and a drive independent from the server.

This remote control unit and the server allow a user to retrieve desired contents data from the server and record the data into a memory card mounted to the remote control unit at the user without moving of the user. In addition, the user can access to the memory card with the remote control unit alone.

### BRIEF DESCRIPTION OF THE DRAWINGS

FIG. 1 is a block diagram of a server system including a server and a remote control unit according to Exemplary Embodiment 1 of the present invention.

FIG. 2 is a block diagram of a signal processor of the server according to Embodiment 1.

FIG. 3 is a block diagram of another signal processor of the server according to Embodiment 1.

FIG. 4 is a flow chart showing an operation of the server according to Embodiment 1.

FIG. 5 is a block diagram of a server system including a server and a remote control unit according to Exemplary Embodiment 2 of the invention.

### DESCRIPTION OF THE PREFERRED EMBODIMENTS

### Exemplary Embodiment 1

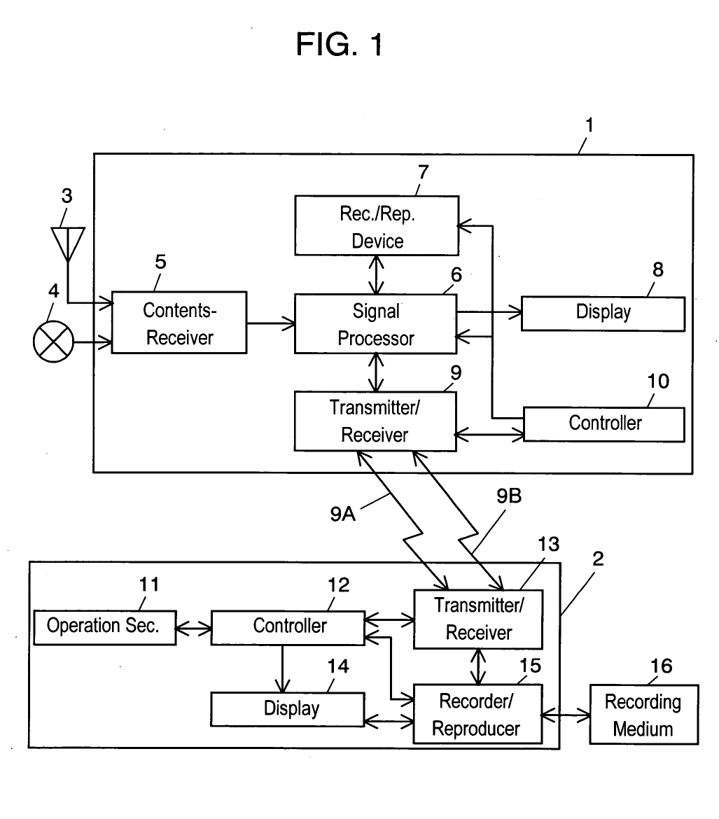

FIG. 1 is a block diagram of a server system including a server and a remote control unit according to Exemplary Embodiment 1 of the present invention. A user can remotely operate server 1 with remote control unit 2. Server 1 includes contents-receiver 5 for receiving contents data containing images and voices through antenna 3 or communications network 4, such as cable TV and Internet, signal processor 6 for compressing and decompressing the contents data, recording/reproducing device 7 for recording and reproducing the contents data, display 8 (may be replaced by a data-output device) for displaying the contents data, transmitter/receiver 9 for transmitting and receiving data to and from remote control unit 2, controller 10 for controlling the above components of server 1. Remote control unit 2 includes operation section 11 having control keys and the like, controller 12 for generating a control signal based on a command from operation section 11, transmitter/receiver 13 for transmitting the control signal received from controller 12 to server 1 and for exchanging contents data with server 1, display 14, and recorder/reproducer 15 for reproducing contents data recorded in recording medium 16 and recording the contents data into recording medium 16. Recording medium 16 is a portable recording medium, such as a memory card removable from remote control unit 2, and may be provided with a nonvolatile semiconductor memory. Operation section 11 is provided with another control key (a button or a switch) for switching an operating mode, in addition to the control keys for remotely controlling server 1.

An operation of the server system including server 1 and remote control unit 2 will be described.

Server 1 records and reproduces contents data of contents of images and voices. The contents data generally flow through the following path:

(1) Contents data received by contents-receiver 5 from antenna 3 and communications network 4 are compressed by signal processor 6, and are recorded into recording/reproducing device 7;

(2) Contents data reproduced from recording/reproducing device 7 are decompressed by signal processor 6, and displayed on display 8;

(3) Contents data received in contents-receiver 5 from antenna 3 and communications network 4 are compressed by signal processor 6, and are transmitted to remote control unit 2 via transmitter/receiver 9;

(4) Contents data reproduced from recording/reproducing device 7 are converted by signal processor 6, and are transmitted to remote control unit 2 via transmitter/receiver 9; and

(5) Contents data received from remote control unit 2 via transmitter/receiver 9 are converted by signal processor 6, and are recorded in recording/reproducing device 7.

As described, server 1 can not only record and reproduce the contents data received by contents-receiver 5 but also transmit and receive the contents data to and from remote control unit 2.

Remote control unit 2 has an ordinary remote control function for controlling the server 1 via the control signal. The control signal is generated in controller 12 according to a command given by the user through operation section 11 and transmitted to server 1 from transmitter/receiver 13. Remote control unit 2 of Embodiment 1 can record the contents data received through transmitter/receiver 13 into removable recording medium 16, besides the ordinary remote control function.

The user can therefore use remote control unit 2 held by the user to record the desired contents data into recording medium 16 by operating server 1 at a location away from server 1 without approaching to the server.

Operation section 11 has an operating mode selector for switching the operation mode of remote control unit 2 between a remote control mode and a mobile mode. In the remote control mode, remote control unit 2 remotely controls server 1, as described above. In the mobile mode, remote control unit 2 operates independently from server 1 to record and reproduce the contents data to and from recording medium 16.

In the remote control mode, remote control unit 2 containing recording medium 16 is qualified as a drive by server 1. In other words, server 1 functions as a host machine for recording medium 16, and remote control unit 2 has an interface function.

When remote control unit 2 is switched to the mobile mode, controller 12 sends a control signal of this mode change. Upon receiving the control signal, controller 10 suspends controlling both remote control unit 2 and recording medium 16. Then, remote control unit 2 is not controlled by server 1 even if remote control unit 2 is located within a communication range of the server 1, so that the user can reproduce the contents data recorded in recording medium 16 and display the data on display 14 by operating the remote control unit 2 independently from the server. In this mode, recorder/reproducer 15 has the function of performing a process necessary to display the contents data.

As described above, the user can use remote control unit 2 as a portable apparatus independent from server 1 by switching the operating mode of remote control unit 2.

In the above description, the user switches the operating mode of remote control unit 2 by using operation section 11. Controllers 10 and 12 may determine whether or not communications can be made between transmitter/receivers 9 and 13, and control server 1 and remote control unit 2, so that remote control unit 2 operates in the remote control mode when they can communicate with each other, and remote control unit 2 operates in the mobile mode when they cannot communicate.

In addition, remote control unit 2 may be provided with an audio output device for producing voices output of the contents data from recorder/reproducer 15, beside display 14.

The control signal is exchanged between transmitter/receiver 9 of server 1 and transmitter/receivers 13 of remote control unit 2 preferably with infrared rays (e.g. IrDA) and the like via communications channel 9A. The contents data is exchanged via wireless communication (e.g. Bluetooth and IEEE802.11x), cable communication (e.g. IEEE1394 and USB), optical communication and the like via another communications channel 9B or channel 9A for the control signal using the infrared rays. In other words, the control signal and the contents data may be transmitted and received in the same communication form through channel 9A, or separately in different communication forms through channels 9A and 9B.

A first transmission rate for transferring data between transmitter/receivers 9 and 13 may not be identical to a second transmission rate for transferring data between recording/reproducing device 7 and signal processor 6. If the first transmission rate is slower than the second transmission rate, the data can be transmitted by allowing signal processor 6 or recording/reproducing device 7 to function as a buffer to slow down the second transmission rate. Server 1 and remote control unit 2 can thus transmit and receive data with high quality (i.e., data compressed at a low compression ratio), while the data is transmitted at a slow speed, even if the transmission rate is low between them.

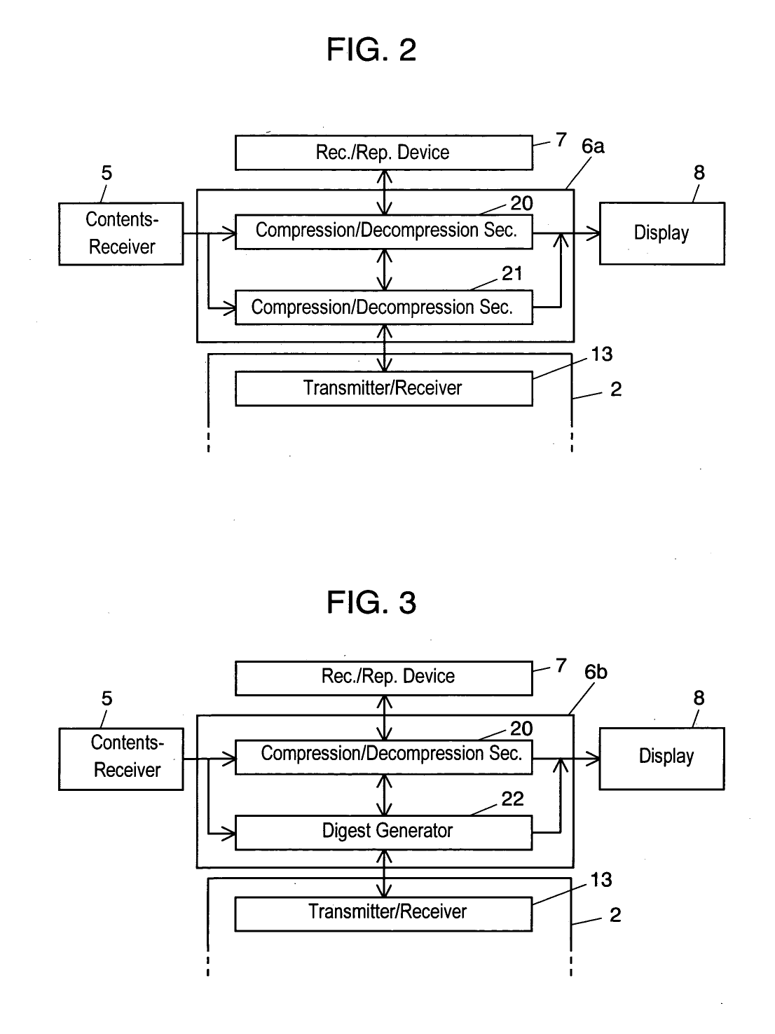

FIG. 2 is a block diagram of signal processor 6a of server 1 according to Embodiment 1. Signal processor 6a includes compression/decompression sections 20 and 21. Compression/decompression section 20 performs compressing and decompressing operation according to Moving Picture Experts Group, Phase 2 (“MPEG-2”), and compression/decompression section 21 performs compressing and decompressing operation according to MPEG-4. In other words, the compression ratio in the compressing and decompressing operation of compression/decompression section 21 is higher than that of the compressing and decompressing operation of compression/decompression section 20 and a bit rate of the data compressed in compression/decompression section 20 faster than that of the data compressed in compression/decompression section 21.

Therefore, when a transmission rate between transmitter/receivers 9 and 13 is slower than a transmission rate to recording/reproducing device 7, the data are transferred at a fast transmission rate of MPEG-2 between recording/reproducing device 7 and compression/decompression section 20, and at the slower transmission rate of MPEG-4 between compression/decompression section 21 and remote control unit 2 via transmitter/receivers 9 and 13.

As discussed above, signal processor 6a can transmit and receive data to and from recording/reproducing device 7 at a fast speed without using buffering control for the data even if the transmission rate of the data is slower between server 1 and remote control unit 2.

Alternately, compression/decompression section 21 may transmit data while changing the compression ratio according to the transmission rate between transmitter/receivers 9 and 13, or in combination with data buffering control. Compression/decompression section 21 may perform the compressing and decompressing operation according to MPEG-2 having a compression ratio higher than that of compression/decompression section 20.

FIG. 3 is a block diagram of another signal processor 6b of server 1 according to Embodiment 1. Signal processor 6b includes compression/decompression section 20 and digest generator 22. For example, compression/decompression section 20 performs compressing and decompressing operation according to MPEG-2, and digest generator 22 thins out contents data along a time axis to generate digest data. Digest generator 22 may generate the digest data from contents data received in contents-receiver 5 via antenna 3 and communications network 4 and from contents data compressed by compression/decompression section 20. When the digest data are generated from the data compressed by compression/decompression section 20, a bit rate of the data is slower than that of the data obtained directly from compression/decompression section 20. This is because digest generator 22 can lower the bit rate per unit time even though the compression ratio remains unchanged since generator 22 thins out the data along the time axis.

When a transmission rate between transmitter/receivers 9 and 13 is slower than the transmission rate to recording/reproducing device 7, the data are transferred at the fast transmission rate of MPEG-2 between recording/reproducing device 7 and compression/decompression section 20, and the digest data can be transmitted at the slower transmission rate between digest generator 22 and remote control unit 2 via transmitter/receivers 9 and 13.

Accordingly, signal processor 6b can transmit and receive the data to and from recording/reproducing device 7 fast without using buffering control even if the transmission rate between server 1 and remote control unit 2 is slow. Rough information of the contents data can be transmitted and received fast between server 1 and remote control unit 2 even when the transmission rate is slow.

Alternately, digest generator 22 may transmit data while changing the compression ratio along the time axis according to the transmission rate between transmitter/receivers 9 and 13, or in combination with data buffering control. Or, server 1 may store the digest data generated by digest generator 22 in recording/reproducing device 7, and then, transmit the stored data to remote control unit 2.

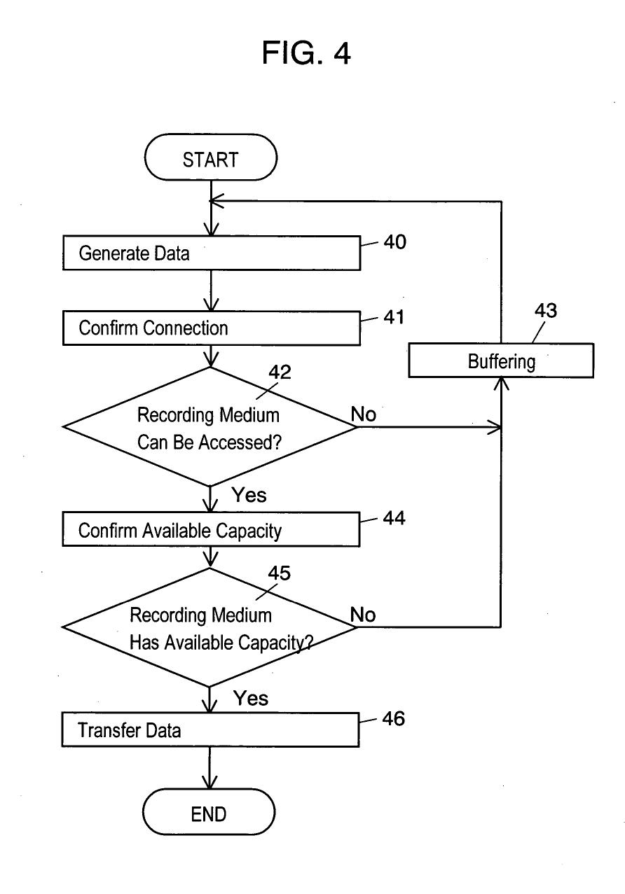

FIG. 4 is a flow chart showing an operation of server 1 according to Embodiment 1.

First, signal processor 6 (6a or 6b) compresses contents data received by contents-receiver 5 from antenna 3 or communications network 4, and compress data stored in recording/reproducing device 7, to generate data to be transmitted to remote control unit 2 (Step 40). Next, controller 10 confirms whether or not communications can be made with remote control unit 2 by checking whether or not a connection is established between transmitter/receivers 9 and 13 (Steps 41 and 42).

If controller 10 confirms at Step 42 that the communications with remote control unit 2 are not possible, controller 10 stores the data generated at Step 40 in a buffer. The buffer may be provided within signal processor 6 (6a and 6b) or transmitter/receiver 9, or implemented by recording/reproducing device 7. Then, the operation at Step 40 is performed.

If controller 10 confirms at Step 42 that communications with remote control unit 2 are possible, controller 10 further confirms whether or not recording medium 16 mounted to remote control 2 has an available capacity to record the data by controller 12 via transmitter/receivers 9 and 13 and recorder/reproducer 15 (Steps 44 and 45).

If controller 10 confirms that recording medium 16 has the available capacity, controller 10 activates recording/reproducing device 7, signal processor 6 (6a or 6b), and transmitter/receiver 9 to transmit the data generated at Step 40 or the data stored in the buffer at Step 43 to remote control unit 2 (Step 46).

If controller 10 confirms that recording medium 16 does not have the available capacity, controller 10 continues storing the data generated in the step 40 into the buffer.

According to Embodiment 1, as described above, server 1 can transmit the contents data after ensuring a communications channel regardless of conditions of remote control unit 2, since controller 10 transmits the data after confirming the establishment of communications between server 1 and remote control unit 2, and confirm the available capacity in recording medium 16. In addition, server 1 can avoid unintended operations, such as suspension during the recording of the data, even when recording medium 16 does not have the available capacity.

According to Embodiment 1, controller 10 confirms a communications between server 1 and remote control unit 2 (Steps 41 and 42) and the available storage capacity in recording medium 16 (Steps 44 and 45). However, the controller may perform only either one of these confirming operations, providing similar effects.

Alternatively, the operating program of the flow chart shown in FIG. 4 may be executed repeatedly on the basis of a predetermined unit of a packet of the data according to conditions of the communications and the available capacity of the recording medium, in order to prepare for interruption of the transmission and reception.

### Exemplary Embodiment 2

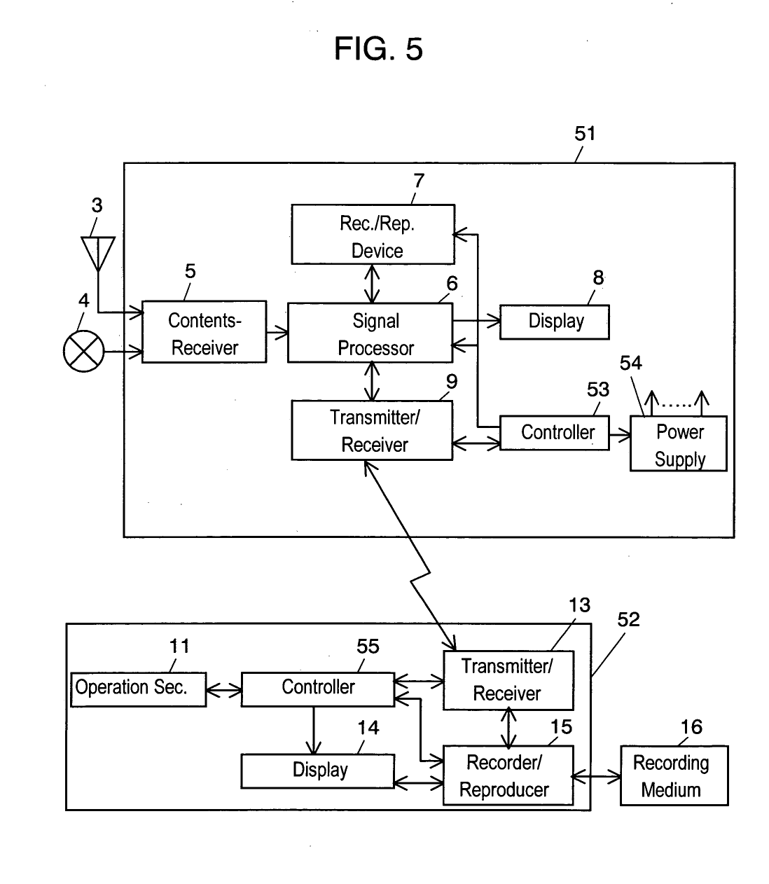

FIG. 5 is a block diagram of a server system including server 51 and remote control unit 52 according to Exemplary Embodiment 2 of the present invention. Like reference characters are used to designate like components as those of the server system shown in FIG. 1, and their descriptions are omitted. Server 51 is provided with power supply 54 for supplying electric power to individual components of server 51, such as signal processor 6, recording/reproducing device 7, and contents-receiver 5, except for transmitter/receiver 9 and controller 53.

In FIG. 5, controller 55 detects through recorder/reproducer 15 whether or not recording medium 16 is mounted to remote control unit 52. If controller 55 detects that recording medium 16 is mounted to remote control unit 52, controller 55 transmits a control signal to transmitter/receiver 9 via transmitter/receiver 13 for turning on the power supply to server 51. In server 51, transmitter/receiver 9 transfers the control signal to controller 53 upon receiving the signal. Controller 53 controls power supply 54 to supply electric power to individual components in server 51 such as signal processor 6, recording/reproducing device 7, and contents-receiver 5. Server 51 has a power supply, other than power supply 54, to supply a power to transmitter/receiver 9 and controller 53 to receive the control signal from remote control unit 52.

According to Embodiment 2, as described above, server 51 turns on the power supply automatically when a user attaches recording medium 16 into remote control unit 52 for recording contents data from server 51. This arrangement allows the user to execute a required operation promptly to transmit the contents data. If recording/reproducing device 7 of server 51 is a hard disk drive, a setup time is necessary after the power supply is turned on. The arrangement reduces power consumption of server 1 since it is not necessary to keep the power supply of server 1 wastefully.

Controller 55 may send another control signal to controller 53 of server 51 via transmitter/receivers 13 and 9 when detecting removal of recording medium 16, so as to cause controller 53 to turn off power supply 54.

Moreover, controller 53 has not only the function of controlling the power supply according to mounting and removal of recording medium 16 to and from remote control unit 52. Controller 53 may send a predetermined command to signal processor 6 to start up a necessary application for executing processes related to transmission and reception of data to and from recording medium 16.

What is claimed is:

1. A remote control unit for operating a server capable of transmitting contents data, said remote control unit being adapted to accept a recording medium, the remote control unit comprising:
a controller for generating a control signal to control the server and the remote control unit;
an operation section for switching an operating mode of the remote control unit;
a transmitter/receiver operable to transmit the control signal generated by the controller to the server, and to receive the contents data from the server; and
a recorder/reproducer operable to
accept the recording medium,
record the contents data received by the transmitter/receiver into the recording medium,
reproduce data from the recording medium, and
output the data to the transmitter/receiver,
wherein, according to the control signal generated by the controller based on the operating mode, the recorder/reproducer is operable to switch a function of the remote control unit between a drive belonging to the server and a drive independent from the server.

2. The remote control unit according to claim 1, wherein the transmitter/receiver transmits the control signal to the server via a first communications channel, and receives the contents data via a second communications channel different from the first communications channel.

3. The remote control unit according to claim 1, wherein the recording medium is removable from the recorder/reproducer.

4. The remote control unit according to claim 3, wherein the controller is operable to detect whether or not the recording medium is mounted to the recorder/reproducer.

5. The remote control unit according to claim 4, wherein the control signal turns on a power supply for the server if the controller detects that the recording medium is mounted to the recorder/reproducer.

6. The remote control unit according to claim 4, wherein the control signal turns off a power supply for the server if the controller detects that the recording medium is not mounted to in the recorder/reproducer.

7. A server system comprising:
a remote control unit; and
a server operable by the remote control unit,
wherein the server comprises
a recording/reproducing device operable to record and reproduce contents data,
a first transmitter/receiver for transmitting and receiving contents data to and from the remote control unit,
a first compression/decompression section operable to compress contents data to be recorded in the recording/reproducing device at a first compression ratio, and decompress contents data reproduced from the recording/reproducing device, and
a second compression/decompression section operable to compress contents data to be transmitted to the first the transmitter/receiver at a second compression ratio higher than the first compression ratio, and decompress contents data from the first transmitter/receiver, and
wherein the remote control unit comprises
a first controller for generating a control signal to control the server,
a second transmitter/receiver operable to transmit the control signal generated by the first controller to the server, and receive the contents data from the server; and
a recorder/reproducer operable to accept a recording medium, the recorder/reproducer being operable to record the contents data received by the second transmitter/receiver into the recording medium, reproduce the data from the recording medium, and output the data to the second transmitter/receiver.

8. The server system according to claim 7, wherein the server further comprises a second controller operable to control the first transmitter/receiver to transmit and receive the contents data to and from the remote control unit if determining that data can be exchanged between the server and the remote control unit.

9. The server system according to claim 7, wherein the server further comprises a second controller operable to control the first transmitter/receiver to transmit and receive the contents data to and from the remote control unit if detecting that the recording medium has an available capacity to record the contents data.

10. A server system comprising:
a remote control unit; and
a server operated by the remote control unit,
wherein the server comprises
a recording/reproducing device operable to record and reproduce contents data,
a first transmitter/receiver operable to transmit and receive contents data to and from the remote control unit,
a compression/decompression section operable to compress contents data to be recorded in the recording/reproducing device, and decompress the contents data reproduced from the recording/reproducing device, and
a digest generator for generating digest data by thinning out the contents data along a time axis, the digest data being adapted to be recorded in the recording/reproducing device, and transmit the digest data to the first transmitter/receiver, and
wherein the remote control unit comprises
a first controller operable to generate a control signal to control the server,
a second transmitter/receiver operable to transmit the control signal generated by the first controller to the server, and receive the digest data from the server, and
a recorder/reproducer operable to accept a recording medium, record the digest data received by the second transmitter/receiver into the recording medium, reproduce data from the recording medium, and output the data to the second transmitter/receiver.

11. The server system according to claim 10, wherein the server further comprises a second controller operable to control the first transmitter/receiver to transmit and receive the digest data to and from the remote control unit if detecting that data can be exchanged between the server and the remote control unit.

12. The server system according to claim 10, wherein the server further comprises a second controller operable to control the first transmitter/receiver to transmit and receive the digest data to and from the remote control unit if detecting that the recording medium has an available capacity to record the digest data.

13. A server system comprising:
a remote control unit; and
a server operable by the remote control unit,
wherein the server comprises
a recording/reproducing device operable to record and reproduce contents data,
a first transmitter/receiver operable to transmit and receive contents data to and from the remote control unit, and
a signal processor operable to transfer the contents data to be recorded in and reproduced from the recording/reproducing device to and from the recording/reproducing device at a first transmission rate, and transfer the contents data to and from the first transmitter/receiver at second transmission rate slower than the first transmission rate, and
wherein the remote control unit comprising
a first controller operable to generate a control signal to control the server,
a second transmitter/receiver operable to transmit the control signal generated by the first controller to the server, and receive the contents data from the server, and
a recorder/reproducer operable to accept a recording medium, record the contents data received by the second transmitter/receiver into the recording medium, reproduce data from the recording medium, and output the data to the second transmitter/receiver.

14. The server system according to claim 13, wherein the server further comprises a second controller operable to control the first transmitter/receiver to transmit and receive the contents data to and from the remote control unit if detecting that data can be exchanged between the server and the remote control unit.

15. The server system according to claim 13, wherein the server further comprises a second controller operable to control the first transmitter/receiver to transmit and receive the contents data to and from the remote control unit when detecting that the recording medium has an available capacity to record the contents data.
